(19) United States
(12) Patent Application Publication
(10) Pub. No.: US 2009/0106170 A1
(43) Pub. Date: Apr. 23, 2009

(54) METHOD AND SYSTEM FOR AIR FARE VERIFICATION AUDITING

(76) Inventors: STEPHEN H. THURLOW, Kansas City, MO (US); Brian A. Pavelka, Atlanta, GA (US); Suzanne R. Callaway, Atlanta, GA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 12/027,792

(22) Filed: Feb. 7, 2008

Related U.S. Application Data
(60) Provisional application No. 60/981,009, filed on Oct. 18, 2007.

(51) Int. Cl. G06Q 10/00

(52) U.S. Cl. 705/400

(57) ABSTRACT

A method and system for air fare verification and auditing for a travel itinerary during a ticketing transaction. A request is received from a customer to verify the air fare for the travel itinerary. The fare verification process determines if the air fare for the travel itinerary is in a fares database. A plurality of rules and restrictions that are applicable to the air fare are validated. The process determines if the air fare passes each of the plurality of rules and restrictions and verifies the air fare if all rules and restrictions are satisfied. A verification response can be provided to the customer for the air fare verification request during the ticketing transaction. An audit report can also be provided via a web reporting tool in near real time.

### BACKGROUND OF THE INVENTION

The present invention relates generally to verification of prices for travel itineraries and, more particularly, to an automated process for considering and applying variances in the numerous factors that affect ticket pricing and ticket reissues.

Every year airlines lose millions of dollars in revenue within their own operations by issuing incorrectly priced tickets in which the price has been manipulated or manually entered by airline employees. The result is an under collection of the appropriate fare. In many companies, the focus of incorrectly priced tickets is on those tickets issued by travel agents. It may be difficult to gain support within a company that millions of dollars are also lost each year due to under collection of fares by internal airline employees. It is common that departments responsible for agency distribution may concentrate on eliminating and/or reducing incorrectly priced agency issued tickets. Departments responsible for revenue accounting, fraud, and yield management may take an additional approach and confirm that internal revenue leakage is and has been a big issue for some time. A concentrated effort must take place within each company to acknowledge and take ownership of the internal problem.

There are various examples of the manner in which internal airline employees are able to price a ticket resulting in the under collection of the appropriate fare. These examples include the following: (1) booking in one class and pricing the ticket in another; (2) manually pricing a ticket with the incorrect currency amount; and (3) applying corporate discounts incorrectly (non-corporate travel, family members). It is very easy for airline employees to issue waivers/favors without the airline ever actually seeing the cumulative total for the week, month, or quarter. It is also common that airline companies do not have the staff to proactively monitor for fraudulent activities and a majority of the fraud that is identified is done so by chance.

Although tools are available in the airline business to automatically price travel itineraries and apply that price to a ticket, many tickets continue to have different prices or reissue amounts attached to them for various reasons. These variances cause airlines to lose huge amounts of revenue due to fraud, human errors, and business decisions that do not take into account the cumulative revenue loss for waiving fare rules.

To understand the significance of airline ticket under-pricing and consequent revenue loss, a simple example illustrates the point. For an airline carrier that issues 200,000 tickets weekly, of which 40,000 are priced by an airline ticket agent, an error rate of 10% in the fare price, representing 4000 tickets, is a conservative estimate. At an average ticket price of $500, the average under-pricing per ticket is $50 (10% of the ticket price). The loss over the course of a year is $10.4 million. Being able to recoup 50% of the lost revenue would generate an additional $5.2 million per year for the airline.

### SUMMARY OF THE INVENTION

Embodiments of the present invention are directed to a system and method for determining if a correct price or reissue amount has been selected for a travel itinerary. The process provides the customer with verification that a correct price or reissue amount was used on the ticket, and if the price used was not the correct price, then the price or reissue amount that should have been used.

The fare verification process provides a way to audit manual tickets by validating if the price used on the ticket was correct. The fare verification tool can be used to detect errors and stop an incorrect transaction from taking place. It can be used to monitor business to generate reports, and it can be used to validate new pricing or reissue systems.

In one aspect of the invention, a method is provided for air fare verification and auditing for a travel itinerary during a ticketing transaction. A request is received from a customer to verify the air fare for the travel itinerary. The fare verification process determines if the air fare for the travel itinerary is in a fares database. A plurality of rules and restrictions that are applicable to the air fare are validated. The process determines if the air fare passes each of the plurality of rules and restrictions and verifies the air fare if all rules and restrictions are satisfied. A verification response is provided to the customer for the air fare verification request during the ticketing transaction.

In another aspect of the invention, a system is provided for air fare verification and auditing for a travel itinerary during a ticketing transaction. The system includes a data storage device, a processor, and a plurality of components that perform the steps of the method when operated on the processor. The components include: a component for receiving a request from a customer to verify the air fare for the travel itinerary; a component for determining if the air fare for the travel itinerary is in a fares database stored in the data storage device; a component for validating a plurality of rules and restrictions that are applicable to the air fare; a component for determining if the air fare passes each of the plurality of rules and restrictions and verifying the air fare if all rules and restrictions are satisfied; and a component for providing a verification response to the customer for the air fare verification request during the ticketing transaction.

In another aspect of the invention, a method is provided for auditing an air fare for a travel itinerary during a ticketing transaction. A request is received from a customer to audit the air fare for the travel itinerary. The fare verification process determines if the air fare for the travel itinerary is in a fares database. A plurality of rules and restrictions that are applicable to the air fare are validated. The process determines if the air fare passes each of the plurality of rules and restrictions and verifies the air fare if all rules and restrictions are satisfied. An audit report is provided to the customer for the air fare verification request in temporal proximity to a completion of the ticketing transaction. The audit report can be provided via a web reporting tool.

### BRIEF DESCRIPTION OF THE DRAWINGS

These and other advantages and aspects of the present invention will become apparent and more readily appreciated from the following detailed description of the invention taken in conjunction with the accompanying drawings, as follows.

FIG. 1 illustrates processing logic for the fare verification process in accordance with an exemplary embodiment of the invention.

FIG. 2 illustrates processing logic for the “keep the fare” process in accordance with an exemplary embodiment of the invention.

FIG. 3 illustrates processing logic for the “find best fare” process in accordance with an exemplary embodiment of the invention.

FIG. 4 illustrates the processing logic for the “reissue fare” process in an exemplary embodiment of the invention.

FIG. 5 illustrates the processing logic for the “find the best reissue amount” process in an exemplary embodiment of the invention.

FIG. 6 illustrates the network architecture for the airline fare verification system an exemplary embodiment.

FIG. 7A illustrates a typical passenger name record (PNR) for an automatically priced fare using an airline reservation system.

FIG. 7B illustrates a passenger name record that has been adjusted manually by the ticket agent to price in a different class of service than the class booked in the PNR.

FIG. 7C illustrates a response that can be transmitted to the ticket agent as a result of the audit by the fare verification system to advise the agent that fare validation has failed.

FIG. 8 illustrates an exemplary aggregate report providing the total count of under priced tickets and the corresponding value of the under priced tickets.

FIG. 9 illustrates an exemplary location report providing the total count of under priced tickets and the corresponding value of the under priced tickets by location.

FIG. 10 illustrates an exemplary specific location report providing each failed ticketing transaction for a specific location.

### DETAILED DESCRIPTION OF THE INVENTION

The following description of the invention is provided as an enabling teaching of the invention and its best, currently known embodiment. Those skilled in the relevant art will recognize that many changes can be made to the embodiments described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and may even be desirable in certain circumstances, and are a part of the present invention. Thus, the following description is provided as illustrative of the principles of the present invention and not in limitation thereof, since the scope of the present invention is defined by the claims.

The fare verification process is activated when a request is made to verify a travel ticket's price. Determining the price or reissue amount for a travel ticket is a complex process that uses many types of rules and restrictions some of which are included in Table 1.

TABLE 1

| RULES | RESTRICTIONS |
|---|---|
| Eligibility | Effective and Discontinue Date |
| Time of Day | Routing |
| Day of Week | Booking Class |
| Season | Flight |
| Advance Purchase | |
| Purchase Within | |
| Minimum Stay | |
| Maximum Stay | |
| Stopover | |
| Transfer | |
| Combinability | |
| Blackout | |
| Surcharge | |
| Accompanied Travel | |
| Travel Date | |
| Sales Location and Security | |
| Fare Construction | |
| Discount | |
| Reissue | |
| Refund | |

The fare verification process is driven by a request from a customer who wishes to have a verification of a travel itinerary. Additionally, it can be used to verify that a ticket that has been reissued has the correct reissue price. The request can come in a variety of forms and can be sent by different media. For example, the request could be an Extensible Markup Language (XML) or EDIFACT message from the customer including the fare basis code(s) and ticket designator. EDIFACT is an acronym for “Electronic Data Interchange For Administration, Commerce, and Transport.” EDIFACT is an international standard for electronic data interchange that is still in widespread use in certain industries such as air travel and tourism because of the substantial investment in legacy software systems that leverage the EDIFACT standard. Generally, the request will include the travel itinerary which has the airline carrier, the flight number, the date and time of both departure and arrival, the departure and arrival locations, and the class of service requested (the class of service is a method that airlines use to control the inventory of seats on an airplane). Travel itineraries may have multiple segments of travel with this information. Additionally, the request will contain information about the passenger (e.g., adult, child, government worker, etc,), fares charged, taxes charged, possibly surcharges charged, as well as other types of charges related to the fare construction rules that are applied. Finally, the request will include information about how the itinerary was priced, using fare basis codes, amounts and where fares were grouped together as a fare break.

The first action of the fare verification process is to attempt to keep the original fare. The original fare may not be the lowest fare available. Sometimes a higher fare can be of benefit when upgrading to a different part of the airplane cabin. Another reason to purchase a higher fare might be to avoid change fees at a later point in the trip. However, a reason for a higher fare may be due to the original fare not meeting the price rules and restrictions for that fare. Thus, the fares that were originally used to price the itinerary need to be verified to determine if they are acceptable.

The next step in keeping the original fare is to locate the fare basis code located in a fares database that was used in pricing the original fare. A fare basis code is a unique alphanumeric code assigned to a fare when the airline files a fare. Frequently, a fare basis code may have a ticket designator or fare modifier attached to the end of it. These fare basis code attachments may signify a type of discount applied, or indicate a special program that might apply to this particular fare. These ticket designators or fare modifiers need to be removed so that the base fare basis code can be located in the fares database. These ticket modifiers or designators will be saved for possible later use.

If the base fare basis code can be located in the fares database, then the rules and restrictions process will begin. A fare basis code database will point to the rules and restrictions that apply to the particular fare. A complex process of determining if the rules apply to the particular fare then begins. This process examines all of the components of the travel itinerary to verify that the rules are met. If any of the rules are not met, the type of rule that failed is noted and the process continues until all of the rules and restrictions have been verified. If the rules and restrictions are verified as accurate, then the ticket designator or fare modifier may be used to match with a correct discount that may be applied, or a correct program that can be used for the fare. Finally, if all rules and restrictions were verified and applied without error, taxes are examined to determine if they have been collected correctly. If all rules and restrictions were verified as accurate and taxes were collected correctly, the keep the fare process is done. An XML or EDIFACT message could then be returned to the customer advising that the fare verification passed (i.e., the original itinerary/ticket request is matched successfully). If the keep the fare process failed, then the reasons for failure are saved and the second fare verification action is taken. Table 3 below provides a list of failure codes.

If the base fare basis code cannot be located in the fares database, then it may be possible that the base fare is a special fare, such as a Category 25 fare. Category 25 fares may be based off a published fare, but the fare amount may be discounted. If a Category 25 fare is not based off of a published fare, it may be a unique private fare. These special fares may use some of the published fares rules and restrictions or they may have their own unique rules and restrictions, or they may be a combination of base fare rules and unique Category 25 rules. At this point in the processing, it needs to be determined which rules will be used in the keep the fare process. A complex process will begin of determining if the rules apply to that fare. This process will look at all of the components of the travel itinerary to verify that the rules are met. If any of the rules are not met, the type of rule is noted and the process continues until all of the rules and restrictions have been verified. Finally, if all rules and restrictions were verified and applied without error, taxes are examined to determine if they have been collected correctly. If all are verified as accurate the keep the fare process is done. If the keep the fare process failed, then the reasons for failure are saved and the second fare verification action is taken.

The second action taken by fare verification process, if the fare could not be kept, is to look for the best possible alternative. This process will consider the class of service that the itinerary used for each segment of travel, and classes above that class of service. This process is not limited to the fare that was originally used, but all eligible fares. These fares must pass all of the fare's rules and restrictions. If the rules and restrictions are verified as accurate, then the ticket designator or fare modifier may be used to match with a correct discount that may be applied or a correct program that can be used for the fare. Finally, if all rules and restrictions were verified and applied without error, taxes are examined to determine if they have been collected correctly. If all are verified as accurate the best possible alternative fare process is done. The data generated by this second action will be saved and reported via a web reporting tool.

In an exemplary embodiment, during the preceding process, if the initial fare verification results in a failure, an XML or EDIFACT message can be returned to the customer advising the customer that the fare verification failed. This enables the customer to interrupt the ticket process. The customer can then send another XML or EDIFACT message including override data. The fare verification process would then price the ticket using the current fares with equal or higher classes of service to determine the correct itinerary/ticket amount. If the customer chooses to ignore the transaction, to use an auto-priced fare, or to recalculate a new price, the transaction will not appear in the web reports, but will pass through the audit process as a new transaction.

At the end of the fare verification process, it is determined whether or not the original fare could be kept. If it could not be kept, there will be reasons for the rules and regulations failure. Also, there will be a best possible fare that should have been used. All this information can be retained for reports and/or returned to the requestor. Ultimately, the verification process will report back to the requestor about the verified itinerary. There are multiple ways for this report to be handled. In an exemplary embodiment, when the travel itinerary passes the audit (i.e., correct fares were used), verification that the fare audit passed is sent back to the requester. The transaction is also counted in a cumulative daily total that can be reported to the customer. When the fare used was not correct, then the rules violated will be reported and the best possible fare also will be reported. This reporting process can be used to stop or pause tickets from being issued with the wrong price. The reports can be used to identify fraud or mistakes that are occurring on tickets being issued. Many uses can be found for these reports. Example reports are discussed further below.

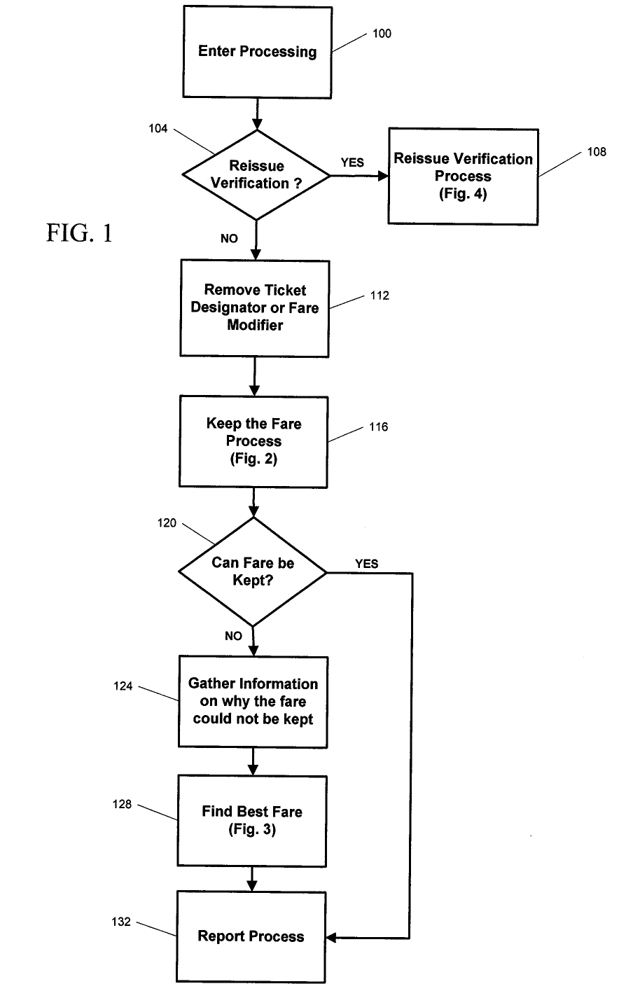

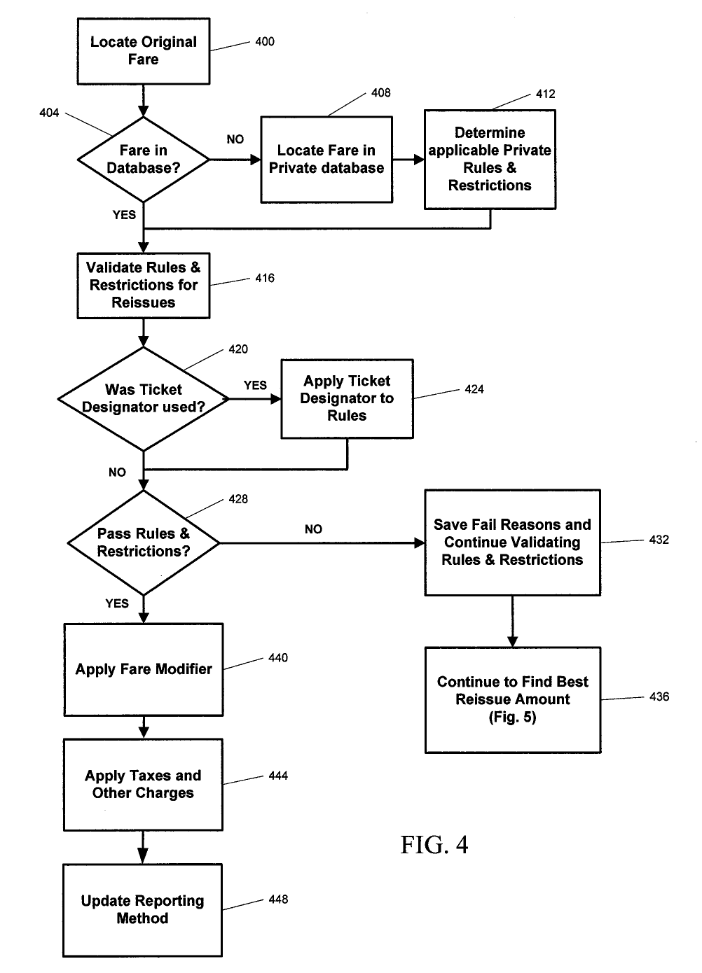

Exemplary processing logic for the fare verification process, corresponding to the preceding description, is illustrated in the flowcharts of FIGS. 1-3. Although the steps of the process are described in a particular order herein, the steps can be performed in a different order, or without performing all of the steps depicted. The processing begins in logic block 100 when a customer requests the verification of a travel itinerary for a passenger. The customer requesting the fare verification can typically be a ticket agent of the airline. Generally, the ticket agent will be an employee of the airline working at an airport ticket counter or a separately located airline ticket facility. In decision block 104, a determination is made as to whether or not the customer request is for a reissue ticket verification. If it is, the reissue verification process illustrated in FIG. 4 is performed as indicated in logic block 108. Otherwise, processing continues in logic block 112. The test for reissue ticket fare verification in decision block 104 is an optional feature of the invention.

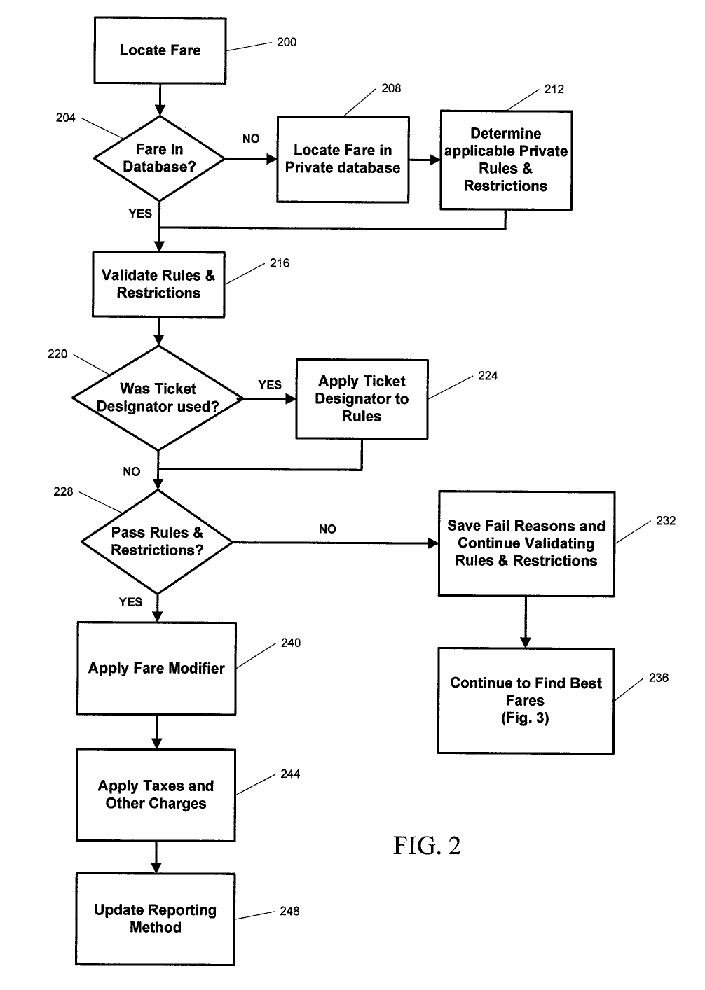

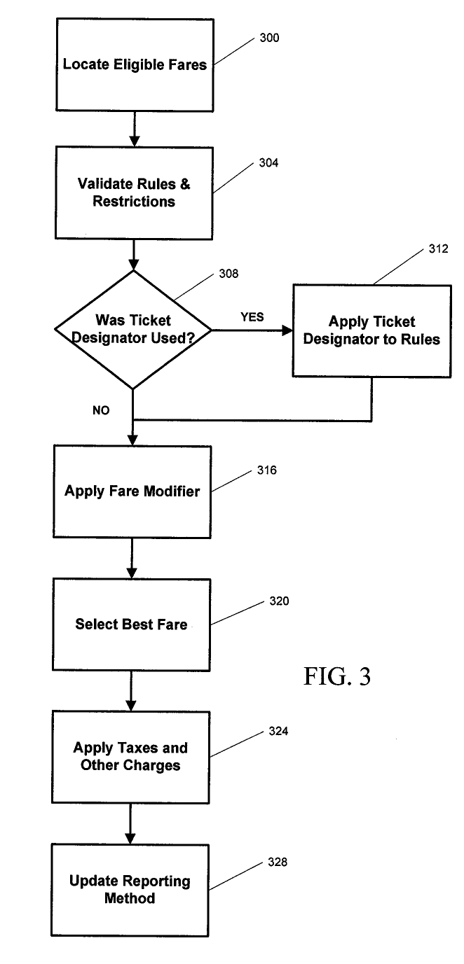

The next step in the processing logic illustrated in FIG. 1 is removing the ticket designator or fare modifier for the travel itinerary if either exists. The ticket designator/fare modifier needs to be removed in order to locate the base fare basis code in the fares database. The ticket designators/fare modifiers are saved for later use. The “keep the fare” process is then performed as indicated in logic block 116, and as illustrated in FIG. 2, discussed below. Decision block 120 is a test for whether or not the fare could be kept. If the fare could be kept, a reporting process is initiated as indicated in logic block 132. For a positive outcome (i.e., fare verified as correct), the reporting process could be to simply track the number of fare verification requests and the number of positive outcomes for subsequent aggregate reporting to the customer. If the fare could not be kept in decision block 120, information is gathered as to why the fare could not be kept as indicated in logic block 124. Processing then transfers to the “find the best fare” process illustrated in FIG. 3, discussed below. The reporting process is initiated in logic block 132 and can include sending a report back to the airline ticket agent at the point of sale to interrupt the transaction to correct the fare for the travel itinerary.

FIG. 2 illustrates the processing logic for the “keep the fare” process in an exemplary embodiment initiated from logic block 116 in FIG. 1. Logic block 200 indicates the step of locating the fare for the travel itinerary in the fare database. Decision block 204 determines whether or not the fare is in the fare database. If the fare for the travel itinerary is not in the fares database, the fare is located in a private special fares database as indicated in logic block 208. Category 25 fares, discussed previously, represent one such special fare having unique rules that could be used in this step. The applicable private rules and restrictions are then determined as indicated in logic block 212. From either decision block 204 (fare in database) or logic block 212 (private rules and restrictions), the next step is to validate the rules and restrictions as indicated in logic block 216. Exemplary rules and restrictions are provided in Table 1 above.

In decision block 220, a test is made to determine if a ticket designator was used. If a ticket designator was used, it is applied to the travel rules as indicated in logic block 224. If it is determined that a ticket designator was not used in decision block 220, or if a ticket designator was applied in logic block 224, processing continues to decision block 228 for determination of whether or not the fare passed the set of rules and restrictions for the particular fare. If the fare did not pass any of the rules and restrictions, the failure reason is saved, and the processing continues to validate the remaining rules and restrictions, as indicated in logic block 232. Exemplary failure codes are provided in Table 3 below. From logic block 232, processing transfers to FIG. 3 to find the best fares, as indicated in logic block 236.

In decision block 228, if the fare passed all rules and restrictions, the fare modifier previously saved is applied to the fare, as indicated in logic block 240. Taxes and other charges are then applied, as indicated in logic block 244. The result is reported to the customer as indicated in logic block 248. In most instances, the result of the successful fare verification process will be accumulated for subsequent reporting, rather than transmitted to the point of ticket transaction.

In an exemplary embodiment, FIG. 3 illustrates the processing logic for the “find the best fare” process initiated from logic block 128 in FIG. 1 (logic block 236 in FIG. 2). Logic block 300 indicates the step of locating eligible fares for the travel itinerary in the fare database. As indicated in logic block 304, the rules and restrictions for the eligible fares are validated. In decision block 308, a determination is made as to whether or not a ticket designator was used. If a ticket designator was used, it is applied to the rules as indicated in logic block 312. If a ticket designator was not used in decision block 308, or if the ticket designator was applied to the rules in logic block 312, the process then applies the fare modifier as indicated in logic block 316. The best fare is selected from the eligible fares as indicated in logic block 320. Taxes and other charges are then applied as indicated in logic block 324. The best fare is then reported to the ticket agent as indicated in logic block 328 to complete the transaction.

A process for validating reissued tickets is also available for verification. Frequently, a traveler needs to modify his ticket after it has been issued. The calculations to reissue are often complex and difficult to verify. The reissue ticket verification process will take similar information as required for a regular ticket plus information about the old and new ticket.

The travel itinerary for both the original ticket and the new (reissue) ticket includes the airline carrier, the flight number, date and time of both departure and arrival, the departure and arrival locations, and the class of service requested (the class of service is a method that airlines use to control the inventory of seats on an airplane). Travel itineraries may have multiple segments of travel with this information. Additionally, the request will contain information about the passenger (examples might be adult, child, government worker, etc.), fares charged, taxes charged, possibly surcharges charged, as well as other types of charges related to the fare construction rules applied. Finally, the request will include information about how the itinerary was reissued using fare basis codes, amounts and where fares were grouped together as a fare break.

The reissue ticket will attempt to keep the reissued fare. If the reissued fare violates rules, then the rule violations will be reported. Reissue rules are the same as a regular ticket pricing, however there are additional rules related to how a ticket can be reissued and some of the refunding rules associated with reissues. When a ticket has been incorrectly reissued, a correct reissue amount will be calculated and reported. Reporting processes can be used in many different ways. Similar to regular pricing a reissue that is taking place can be stopped until the correct reissue amount is charged, or a reason for the incorrect amount is given. As in regular price verification, reporting can be done outside of the flow of the transaction and may be used to identify fraud or mistakes that are being made.

FIG. 4 illustrates the processing logic for the “reissue fare” process in an exemplary embodiment initiated from logic block 108 in FIG. 1. Logic block 400 indicates the step of locating the original fare and reissue fare for the travel itinerary in the fares database. Decision block 404 determines whether or not the original fare and reissue fare are in the fares database. If the original fare and reissue fare for the travel itinerary are not in the fare database, the original and reissue fare are located in a private special fares database as indicated in logic block 408. Category 25 fares, discussed previously, represent one such special fare having unique rules that could be used in this step. The applicable private rules and restrictions are then determined as indicated in logic block 412. From either decision block 404 (fares in database) or logic block 412 (private rules and restrictions), the next step is to validate the rules and restrictions for the reissue fare process as indicated in logic block 416.

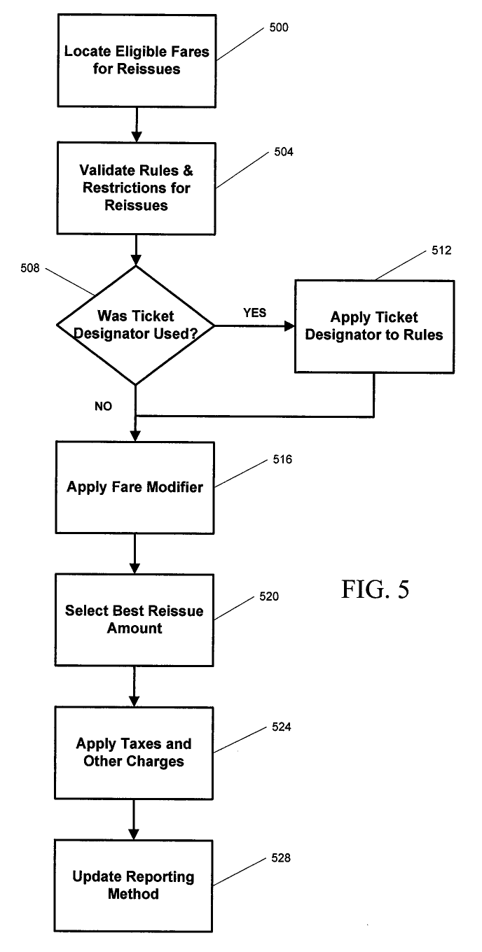

In decision block 420, a test is made to determine if a ticket designator was used. If a ticket designator was used, it is applied to the reissue fare rules as indicated in logic block 424. If it is determined that a ticket designator was not used in decision block 420, or if a ticket designator was applied in logic block 424, processing continues to decision block 428 for determination of whether or not the reissue fare passed the set of rules and restrictions for the particular fare. If the reissue fare did not pass any of the rules and restrictions, the failure reason is saved, and the processing continues to validate the remaining rules and restrictions for the reissue fare, as indicated in logic block 432. Exemplary failure codes are provided in Table 3 below. From logic block 432, the process transfers to FIG. 5, as indicated in logic block 436, to find the best reissue amount.

In decision block 428, if the reissue fare passed all rules and restrictions, a fare modifier can be applied to the fare, as indicated in logic block 440. Taxes and other charges are then applied, as indicated in logic block 444. The result is reported to the customer as indicated in logic block 448. In an exemplary embodiment, each successful reissue fare verification transaction will be counted for subsequent reporting, rather than transmitted to the point of ticket transaction. Each fare verification transaction that fails (i.e., an error is detected) can be reported in real time to the customer via a web reporting tool.

FIG. 5 illustrates the processing logic for the “find the best reissue amount” process in an exemplary embodiment initiated from logic block 436 in FIG. 4. Logic block 500 indicates the step of locating eligible fares for ticket reissues in the fare database. As indicated in logic block 504, the rules and restrictions for the eligible reissue fares are validated. In decision block 508, a determination is made as to whether or not a ticket designator was used. If a ticket designator was used, it is applied to the reissue rules as indicated in logic block 512. If a ticket designator was not used in decision block 508, or if the ticket designator was applied to the reissue rules in logic block 512, the process then applies the fare modifier as indicated in logic block 516. The best reissue amount is selected from the eligible reissue fares as indicated in logic block 520. Taxes and other charges are then applied as indicated in logic block 524. The best reissue amount is then reported to the ticket agent as indicated in logic block 528 to complete the ticket reissue transaction.

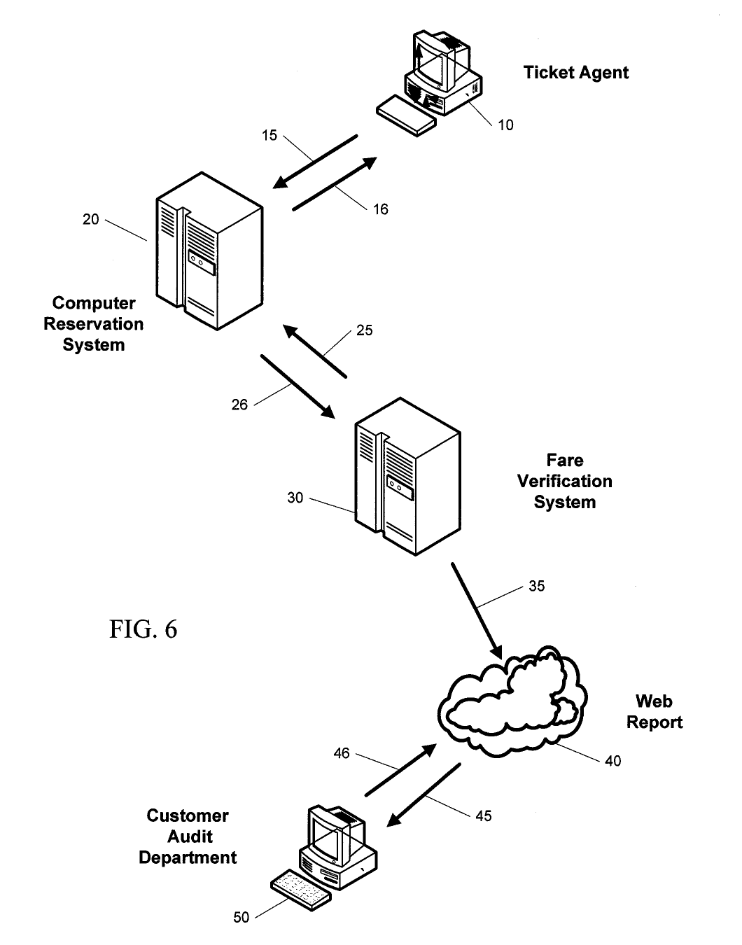

An exemplary embodiment of the network architecture for the air fare verification system is illustrated in FIG. 6. A ticket agent 10 communicates over a high speed communication link 15 with a computer reservation system (CRS) 20 for specific flight information to create a travel itinerary, and receives the requested information which is then relayed to the passenger in order to book a particular flight or flights with a particular class of service. The ticket agent 10 can book the flight and class of service if seats in the class are available. Although only a single ticket agent is shown in FIG. 6, there are no limitations on the number of ticket agents, the physical locations of the ticket agents, or the type of ticket agents (airline ticket agent, travel agency ticket agent, supervisor, manager, etc.). Likewise, the computer reservation system 20 can represent a plurality of separate computer reservation systems provided by airlines or global distribution system providers, such as Worldspan and Galileo.

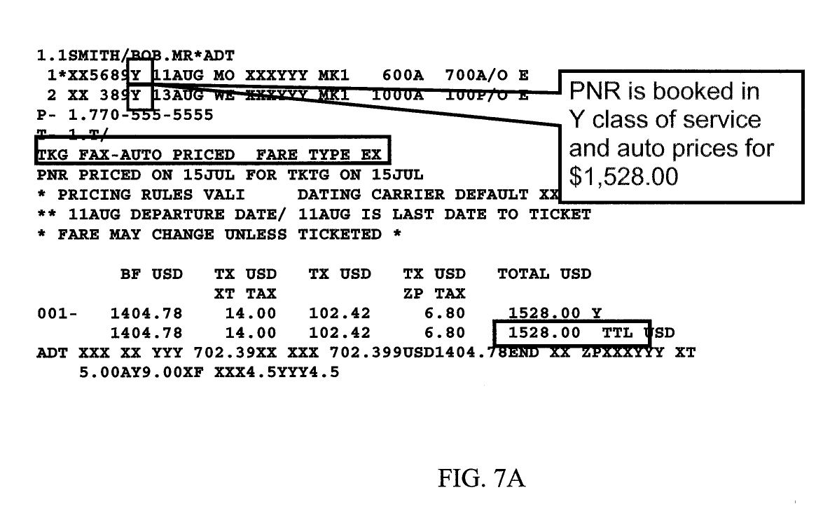

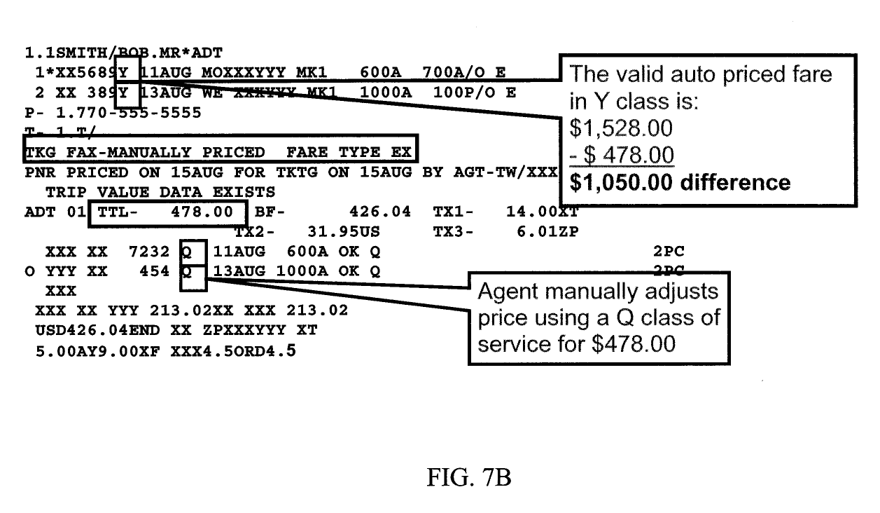

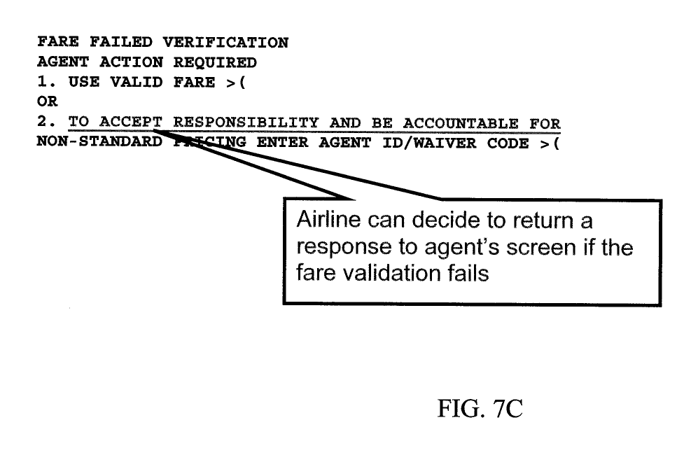

A typical passenger name record (PNR) for an automatically priced fare that would show on the ticket agent's computer screen is depicted in FIG. 7A. The annotations indicate that the PNR is booked in coach (Y) class of service and automatically priced by the computer reservation system at $1,528. The computer reservation system 20 can communicate over a high speed communication link 25 with fare verification system 30 in response to a request from the ticket agent 10. The fare verification system 30 provides a response to the ticket agent 10 via high speed communication links 16, 26. The fare verification system provides audit reports over a wideband communication network (e.g., the Internet) 40 to a customer audit department 50 via communication links 35, 45. FIG. 7B illustrates the ticket agent 10 overriding the valid automatically priced fare of FIG. 7A by manually adjusting the fare price using a Q class of service, for which the fare is $478. The fare verification system 30, in response to a fare verification request, could return a message such as that depicted in FIG. 7C indicating that the fare failed verification.

In an alternative embodiment, the network system illustrated in FIG. 6 does not include a separate communication link 16 for providing a fare verification response to the ticket agent 10. In this alternate embodiment, the customer 50 requests an audit report for a ticket transaction initiated by the ticket agent 10. The request can be sent over communication link 46. An audit report can also be sent automatically from the verification system 30 to the customer 50 for every ticketing transaction initiated by ticket agent 10. The verification system 30 verifies the airline fare for the transaction, but does not send a response back to the ticket agent 10 to interrupt the transaction. Instead an audit report is transmitted from the verification system to the customer 50 via the wideband network 40 and communication link 45 immediately following completion of the ticketing transaction. This alternative embodiment is appropriate for situations in which the customer wants to monitor ticket agent performance for educational or training purposes, but does not want to interrupt the ticketing process.

Web reporting allows the transactions identified in the audit process to be available online for review within minutes. Each responsible area within the customer's company can then follow-up on the tickets in question and determine why each ticket was under/over-priced (e.g., training, mistake, fraud, etc.). Documentation and reports can be used to reduce/stop errors, remove employees from positions in which they have the ability to commit fraud, and reduce the number of fare waivers/favors. The task of stopping revenue leakage on internally issued tickets is not easy. The fare verification process allows companies to audit, follow-up and/or stop the transaction, but it also takes a firm commitment from all areas within the company to successfully begin to eliminate this type of revenue loss.

There can be multiple levels of reporting. For example, a first level of reporting can include all transactions that failed the audit. A second level of reporting can include all transactions that failed the audit and were overridden subsequently by the customer. Several reports can be made available to the customer including aggregate reports, location reports, and specific location reports.

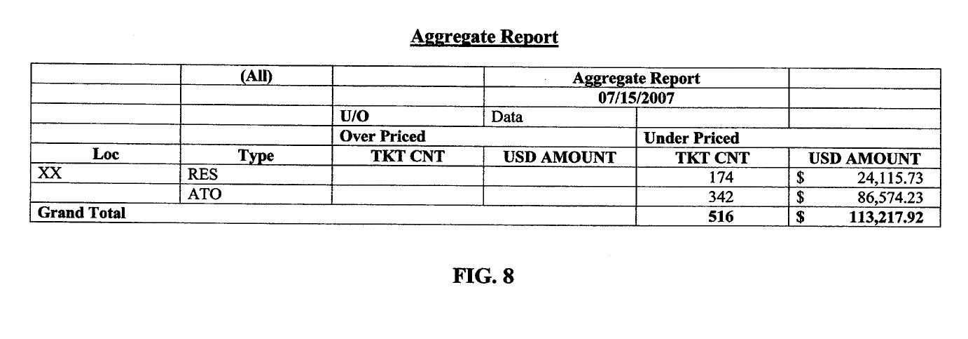

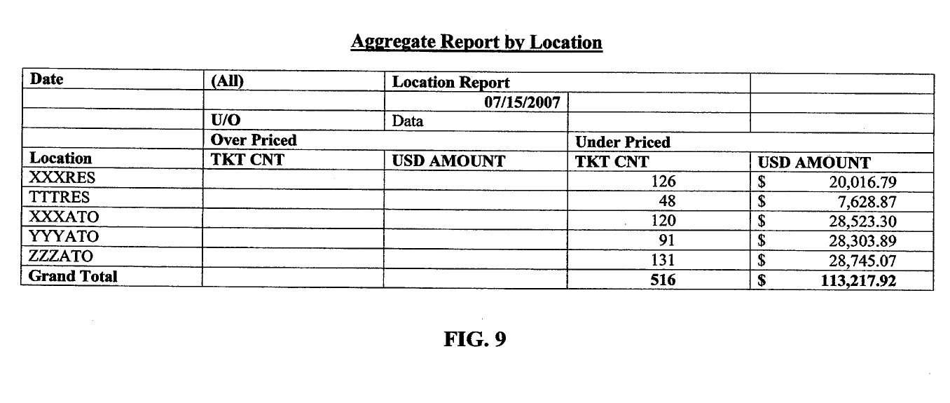

An aggregate report is designed for senior management to review revenue dilution/leakage by location type. Examples of location types include all reservations, all airport ticket offices and all city ticket offices. FIG. 8 illustrates an exemplary aggregate report. The location report is designed for the next level of management to review revenue dilution/leakage one level down from the aggregate report. This report enables the user to review dilution/revenue leakage by each city and location type. FIG. 9 illustrates an exemplary location report. The aggregate and location reports would be displayed typically in the default airline currency (e.g., USD, EUR).

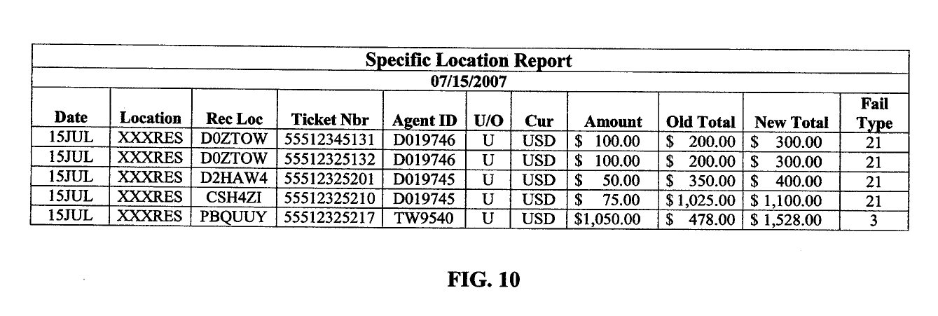

The specific location report is designed for the supervisor/station manager to review/follow-up with the agent who issued the ticket in question. Each transaction appearing on the specific location report is accompanied by the specific details required to review the transaction with the agent (e.g., Record Locator, Ticket Number, Agent ID, Waiver Code, Amount, Failure Code, etc.). The specific location report could be displayed typically in the default airline currency and/or the local currency. The specific location report would be available to view one city and one location at a time. In addition, the specific location report could have a web filter to allow further customization of the display presented to the customer. FIG. 10 illustrates an exemplary specific location report. Table 2 identifies standard data for the specific location report.

TABLE 2

```
Carrier Code
Country
City
Type of Location (e.g., RES, ATO, CTO)
Record Locator
Ticket Number
Agent ID
Discrepancy Type:
    U = Under priced itinerary,
    O = Overpriced itinerary,
    P = Fare Calculation/Parser error,
    E = Fare Basis Code Error - unable to match FBC
    in message to FBC in Ticket
        Pricing System
Currency
Discrepancy Amount (Amount PNR Is Under/Over Priced)
Total Fare For Transaction (Total Old Fare)
Total Fare Determined By Fare Verification System (Total New Fare)
Fail Code (see list of fail codes in next section)
Fare Basis Ticket Designator
Waiver Code
Passenger Name
Override Indicator
Local/Ticketing Date and Time
Zulu Time For Ticketing
```

Exemplary failure type codes that can be used in the specific location report are shown in Table 3.

TABLE 3

| FAILURE CODE | EXPLANATION |
|---|---|
| 1 | Fare Basis Code Not Found |
| 2 | Invalid Fare Amount |
| 3 | Invalid Booking Code |
| 4 | Routing |
| 5 | Invalid Fare For PTC |
| 6 | Taxes/Fees |
| 7 | Invalid OA Booking Code |
| 10 | Sales Restriction |
| 11 | Travel Date |
| 12 | Advance Purchase |
| 13 | Minimum Stay |
| 14 | Stopover |
| 15 | Day/Time |
| 16 | Transfers |
| 17 | Maximum Stay |
| 18 | Blackout |
| 19 | Seasonality |
| 20 | Purchase Within |
| 21 | Flight Application |
| 22 | Combinability |

The specific location report can be customized by the customer by addition of extra fields for each transaction. For example, a field could be used for follow-up with the agent issuing a transaction to explain the corrective action that was taken. The data provided on all reports is available within minutes via the web reporting tool. This enables the customer to discuss a transaction in question with the ticket agent in near real time.

Embodiments of the invention described herein provide unique benefits to the customer. These benefits include, but are not limited to, the capabilities (1) to audit the price of the travel itinerary during the ticketing transaction rather than after the transaction has taken place; (2) to alert the agent making the ticket transaction in real-time that the fare being collected is not correct before any revenue is lost; and (3) to provide near real-time reports (i.e., in time proximity to completion of the ticketing transaction) via a web reporting tool for all ticket transactions sent through the verification system that are ticketed for the wrong amount. Without the fare verification system described herein, customers can conduct audits only after ticketing transactions are completed. The customer has no ability to regain the lost revenue. Using embodiments described herein to verify ticketing transactions enables the customer to eliminate or greatly reduce revenue leakage since a real-time response is displayed to the customer in order to correct the price prior to completing the transaction.

The system and methods of the present invention have been described as computer-implemented processes. It is important to note, however, that those skilled in the art will appreciate that the mechanisms of the present invention are capable of being distributed as a program product in a variety of forms, and that the present invention applies regardless of the particular type of physical signal bearing media utilized to carry out the distribution. Examples of signal bearing media include, without limitation, recordable-type media such as diskettes or CD ROMs.

The corresponding structures, materials, acts, and equivalents of all means plus function elements in any claims below are intended to include any structure, material, or acts for performing the function in combination with other claim elements as specifically claimed. Those skilled in the art will appreciate that many modifications to the exemplary embodiments are possible without departing from the scope of the present invention.

In addition, it is possible to use some of the features of the present invention without the corresponding use of the other features. Accordingly, the foregoing description of the exemplary embodiments is provided for the purpose of illustrating the principles of the present invention, and not in limitation thereof, since the scope of the present invention is defined solely by the appended claims.

What is claimed:

1. A method for air fare verification and auditing for a travel itinerary during a ticketing transaction, comprising the steps of:
receiving a request from a customer to verify the air fare for the travel itinerary;
determining if the air fare for the travel itinerary is in a fares database;
validating a plurality of rules and restrictions that are applicable to the air fare;
determining if the air fare passes each of the plurality of rules and restrictions and verifying the air fare if all rules and restrictions are satisfied; and
providing a verification response for the air fare verification request to the customer during the ticketing transaction.

2. The method for air fare verification and auditing of claim 1 wherein the step of determining if the air fare for the travel itinerary is in a fares database comprises searching a published fares database.

3. The method for air fare verification and auditing of claim 1 wherein the step of determining if the air fare for the travel itinerary is in a fares database comprises searching a special fares database.

4. The method for air fare verification and auditing of claim 3 further comprising determining a plurality of rules and restrictions that are applicable to the special fares.

5. The method for air fare verification and auditing of claim 1 further comprising saving and reporting a failure reason for each rule and restriction that is not satisfied by the air fare, if the air fare did not pass all rules and restrictions applicable to the air fare.

6. The method for air fare verification and auditing of claim 1 further comprising determining a best fare among a plurality of eligible fares, if the air fare did not pass all rules and restrictions applicable to the air fare.

7. The method for air fare verification and auditing of claim 1 further comprising removing a ticket designator or fare modifier associated with the air fare.

8. The method for air fare verification and auditing of claim 7 further comprising applying the ticket designator to the plurality of rules and restrictions prior to the step of determining if the air fare passes each of the plurality of rules and restrictions.

9. The method for air fare verification and auditing of claim 7 further comprising applying the fare modifier if the air fare passes each of the plurality of rules and restrictions.

10. The method for air fare verification and auditing of claim 1 further comprising interrupting the ticketing transaction if the air fare did not pass all rules and restrictions applicable to the air fare.

11. The method for air fare verification and auditing of claim 1 further comprising determining if the received request is for a reissue ticket verification.

12. The method for air fare verification and auditing of claim 11 further comprising:
locating a plurality of eligible fares for the reissue ticket request in the fares database; and
selecting a best reissue amount from the plurality of eligible fares for the reissue ticket request.

13. A system for air fare verification and auditing for a travel itinerary during a ticketing transaction, comprising:
a data storage device;
a processor for executing a plurality of components including:
a component for receiving a request from a customer to verify the air fare for the travel itinerary;
a component for determining if the air fare for the travel itinerary is in a fares database stored in the data storage device;
a component for validating a plurality of rules and restrictions that are applicable to the air fare;
a component for determining if the air fare passes each of the plurality of rules and restrictions and verifying the air fare if all rules and restrictions are satisfied; and
a component for providing a verification response for the air fare verification request to the customer during the ticketing transaction.

14. The system for air fare verification and auditing of claim 13 wherein the component for determining if the air fare for the travel itinerary is in a fares database comprises a module for searching a published fares database.

15. The system for air fare verification and auditing of claim 13 wherein the component for determining if the air fare for the travel itinerary is in a fares database comprises a module for searching a special fares database.

16. The system for air fare verification and auditing of claim 15 further comprising a component for determining a plurality of rules and restrictions that are applicable to the special fares.

17. The system for air fare verification and auditing of claim 13 further comprising a component for saving in the data storage device, and reporting to the ticket transaction location, a failure reason for each rule and restriction that is not satisfied by the air fare, if the air fare did not pass all rules and restrictions applicable to the air fare.

18. The system for air fare verification and auditing of claim 13 further comprising a component for determining a best fare among a plurality of eligible fares, if the air fare did not pass all rules and restrictions applicable to the air fare.

19. The system for air fare verification and auditing of claim 13 further comprising a component for removing a ticket designator or fare modifier associated with the air fare.

20. The system for air fare verification and auditing of claim 19 further comprising a component for applying the ticket designator to the plurality of rules and restrictions prior to determine if the air fare passes each of the plurality of rules and restrictions.

21. The system for air fare verification and auditing of claim 19 further comprising a component for applying the fare modifier if the air fare passes each of the plurality of rules and restrictions.

22. The system for air fare verification and auditing of claim 13 further comprising a component for interrupting the ticketing transaction if the air fare did not pass all rules and restrictions applicable to the air fare.

23. The system for air fare verification and auditing of claim 13 further comprising a component for determining if the received request is for a reissue ticket verification.

24. The system for air fare verification and auditing of claim 23 further comprising:
a component for locating a plurality of eligible fares for the reissue ticket request in the fares database; and
a component for selecting a best reissue amount from the plurality of eligible fares for the reissue ticket request.

25. A method for air fare auditing for a travel itinerary during a ticketing transaction, comprising the steps of:
receiving a request from a customer to audit the air fare for the travel itinerary;
determining if the air fare for the travel itinerary is in a fares database;
validating a plurality of rules and restrictions that are applicable to the air fare;
determining if the air fare passes each of the plurality of rules and restrictions and verifying the air fare if all rules and restrictions are satisfied; and
providing an audit report for the air fare audit request to the customer in temporal proximity to a completion of the ticketing transaction.

26. The method for air fare auditing for a travel itinerary of claim 25 wherein the audit report is provided via a web reporting tool.

27. The method for air fare auditing for a travel itinerary of claim 25 further comprising saving and reporting a failure reason for each rule and restriction that is not satisfied by the air fare, if the air fare did not pass all rules and restrictions applicable to the air fare.

28. The method for air fare auditing for a travel itinerary of claim 25 wherein the audit report includes each transaction that failed the audit for a plurality of ticketing transactions.

29. The method for air fare auditing for a travel itinerary of claim 25 wherein the audit report includes each transaction that failed the audit for a plurality of ticketing transactions, and that were overridden subsequently by the customer.

30. The method for air fare auditing for a travel itinerary of claim 25 wherein the audit report comprises at least one of an aggregate report for all locations and a location report for a specific location.
